(19) United States
(12) Patent Application Publication
(10) Pub. No.: US 2011/0216017 A1
(43) Pub. Date: Sep. 8, 2011

(54) Touch Panel Apparatus

(76) Inventors: Pin-Hung CHOU, Taipei City (TW); Yu Hung LI, Taoyuan City (TW)

(21) Appl. No.: 12/831,340

(22) Filed: Jul. 7, 2010

(30) Foreign Application Priority Data
Mar. 4, 2010 (TW) 099106290

(51) Int. Cl. G06F 3/041

(52) U.S. Cl. 345/173

(57) ABSTRACT

The present invention discloses a touch panel apparatus with shared output pin configuration and method thereof. The method to reduce output pin is to group the electrode lines on the substrate into at least one unit, and each unit includes plural lines. At least one of the second axial electrode line of the electrode line group and at least one of the second axial electrode line of the another electrode line group couple to plural the second axial pins. Then, the vertical electrodes deliver the signals to the control IC through the pin coupled with the control IC. The control IC sends the output signals to the micro controller unit and the micro controller unit utilizes logical operators to estimate the coordinate position of touch point.

### FIELD OF THE INVENTION

The present invention relates to a touch panel apparatus, and more particularly to a touch panel apparatus with shared output pins configuration of vertical electrodes.

### BACKGROUND OF THE INVENTION

With rapid developments and applications of the technology, the input devices of the information, communications and electronics products and other related devices tend to diversify. Because of the humanity input interface, touch panel has become an essential means for human life. User is free of teaching and can use through an intuitive and direct touching.

The principle of the touch panel technology is that when user's fingers or other media touch on the touch panel screen, the coordinates of the touch points are detected by different induction types, e.g. voltage, current, sound wave or infrared. The touch panel can be divided into various categories according to different driving modes of the touch panel, for example, a resistive panel, a capacitive panel, a surface acoustic wave panel, an optical imaging panel, and so on. Users can select the category of touch panel base on the character of products. Presently, a resistive touch panel has high market share because of having no limitation to touch media such as human finger, pen, or short stick. Therefore, the resistive touch panel can be used in various type products and the mainstream application is consumer electronics such as table service point of sale system (Table service POA), personal digital assistant (PDA), mobile phone, inventory management machine, electronics dictionary, electronics at the point of sale (EPOS) and medical monitoring system.

The resistive touch panel is formed by two ITO conductive layers disposed correspondingly, which are configured the X and Y axis electrode wires respectively. When user touches the panel, the top and bottom electrodes are conducted by the touching pressure, and a controller detects the voltage difference of touch panel from the top and the bottom electrodes to generate ON/OFF function. Then, the ON/OFF signals are transmitted to the controller to compute and determine the coordinates of touch point. The resistive touch panel can be divided into a matrix resistive touch panel and an analog resistive touch panel according to the output mode of signals. The analog resistive touch panel is a conventionally used resistive touch panel, which further divided the categories into four wires, five wires, six wires, seven wires and eight wires in accordance with the configuration of the top and the bottom electrodes wires. However, the relevant industries attach importance to application of the matrix resistive touch panel gradually, because of the lower price and cost.

The technical principle of the matrix resistive touch panel is that the top and the bottom electrodes are the X side horizontal electrode and the Y side vertical electrode respectively. With reference to FIG. 1, when user touches the touch panel, the X side pulse signals to X side horizontal electrode from X₁˜Xₙ in sequence within a certain time T, generally it is a frame time 16.67 millisecond (ms). Then, the X side pulsing signals are detected and output by the Y side vertical electrode Y₁˜Yₙ. Finally, the Y side integrated circuit (IC) receives and determines the output signals from the Y side electrode. FIG. 2 illustrates a flow chart of the process of the matrix resistive touch panel. First, the X side electrode wires pulse signals to the X side electrode S1, and the Y side electrode wires detect the pulsing signals transmitted from the X side electrode S2. Then, the pulsing signals are transmitted to the Y side IC S3. The Y side IC outputs the received signals to the micro control unit (MCU) S4 to determine the horizontal and the vertical coordinate position within a certain time T and get the correct coordinates position of the touching point S5. Finally, the MCU outputs the coordinates to the outside S6. The major difference between the analog resistive touch panel and the matrix resistive touch panel is that the matrix resistive touch panel can be used with the controller IC design, and doesn't have to collocate with convert circuit design, so that the matrix resistive touch panel can reduce the cost.

However, the conventional wires configuration design of the Y side vertical electrode employs every second axis electrode wires coupled to an output pin of the Y side control IC. Thus, every output pin only receives the signals from a single area. FIG. 3 illustrates a diagram of the configuration of conventional matrix resistive touch panel. As shown in figure, when user pressures on the touch point P, the signals of X side pulse to the X side electrode, and the Y side vertical electrode detects the pulsing signals of X side Y₁₁˜Y₁₃. Then, the pulsing signals of X side are transmitted to the Y side control IC via the output pins coupled with the Y side control IC, and the signals of the Y side control IC received are Y_{11′}˜Y_{13′}. Thus, the MCU can determine the position of touch point is Y₁₁˜Y₁₃ after the Y side control IC transmits the signals Y_{11′}˜Y_{13′} to the MCU. As shown in the figure, every output pin of the Y side vertical electrode only receiving the signals from the single area, that is to say, the larger size of the panel is, the more input pins of Y side IC is needed, and the more data amount should be computed by the MCU, especially the multi-touch may lead the responding speed of touch panel lower.

### SUMMARY OF THE INVENTION

It is therefore an object of the invention to share the output pins of electrode for reducing the amount of the electrode output pins and economizing manufacture cost.

Another object of the invention is to reduce the computing data amount of the MCU and the responding time of the MCU, it should enhance the responding speed of the touch panel and increase the accuracy of the estimation of the position. The present invention provides a responsive touch panel to enhance processing efficiency.

In order to achieve the above identified object, the present invention discloses a method for reducing the amount of the output pins of electrode by various arrangements and combinations. The present invention discloses a touch panel apparatus with shared output pins configuration, the apparatus includes: a first substrate with a first axis electrode layer formed thereon, wherein the first axis electrode layer including plural first axis electrode wires; a second substrate with a second axis electrode layer is formed thereon, wherein the second axis electrode layer includes plural second axis electrode wires, and the second substrate is disposed on the first substrate correspondingly; and a space layer is disposed between the first axis electrode layer and the second axis electrode layer for separating the first axis electrode layer and the second axis electrode layer. The first axis electrode wires and the second axis electrode wires are interlaced mutually to form a matrix configuration, the first axis electrode wires are coupled with the plural first axis pins to transmit the pulsing signals to the first axis electrode layer within a predetermined time, and the plural second axis electrode wires are coupled with a control IC via the plural second axis pins to transmit the signals to control IC within a predetermined time.

In embodiment of the present invention, the K of M second axis electrode wires are taken as a unit and the M second axis electrode wires are divided into M/K electrode wire groups. A second electrode wire of an electrode wire group and a second electrode wire of the another electrode wire group are selected to couple jointly with the one of the second axis pins, wherein the second axis pins can be plurality and K is an integer which is more than or equal to 2. For example, the three of the second axis electrode wires are taken as a unit, so that the electrode wires 1˜3 are regarded as a first group and the electrode wires 4˜6 as a second group. The electrode wires 1 and 4 are selected to couple jointly with the second axis pin 1. Therefore, when the second axis electrode wire 4 output the signals to control IC, the signals are output via the second axis pin 1, which should be output via the second axis pin 4 originally. Thus, the amount of the vertical electrode output pins could be reduced effectively, that is to say, the amount of the input pins of the control IC are reduced. In the present invention, the amount of pins of each group could be designed according to the touch panel application requirement and condition of the single-point or multi-point.

The present invention discloses a method for transmitting signals to control IC by grouping the Y side electrode wires into every three or more than three wires as a unit and an electrode wire is selected from each group. Then, an electrode wire of the one of the groups and an electrode wire of another group are coupled jointly to the one of the second axis pins, and the signals are transmitted to the control IC. In other words, electrode wires selected from every electrode wire groups are coupled with the same output pin. When the output signals transmit to the control IC, the output signals would be transmitted via the pin and the control IC would interpret and determine the several of arrangement and combination to represent the signal by logic computing method. Because of the present invention utilizes the arrangement and combination of the electrode output pins and logic computing method to increase the transmittable area of each pin, and instead of the conventional pin which only transmits the signals from single area to control IC. Therefore, the present invention can reduce the amount of the electrode output pins efficiently and the computing data amount of the MCU is reduced accordingly.

One of the merits of the present invention is to save the amount of the electrode output pins and economize the manufacture cost.

Another merit of the present invention is to reduce the computing data amount of the control IC and enhance the responding speed of the touch panel.

Further merit of the present invention is collocated with application, such as the size of the products, and increases the efficiency of the touch panel by logic computing method.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention.

FIG. 1 shows a diagram of the principle of the matrix resistive touch panel technology.

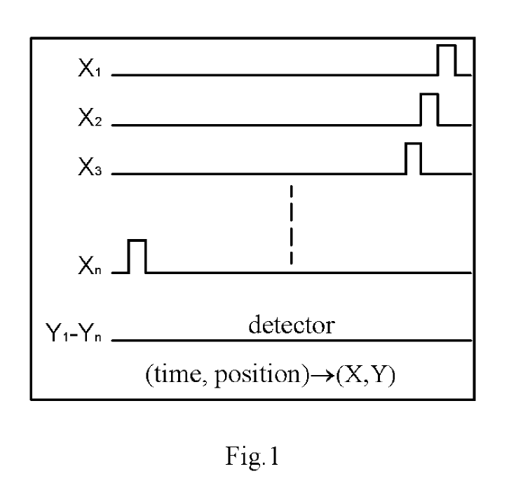

FIG. 2 shows a flow chart of the process of the matrix resistive touch panel.

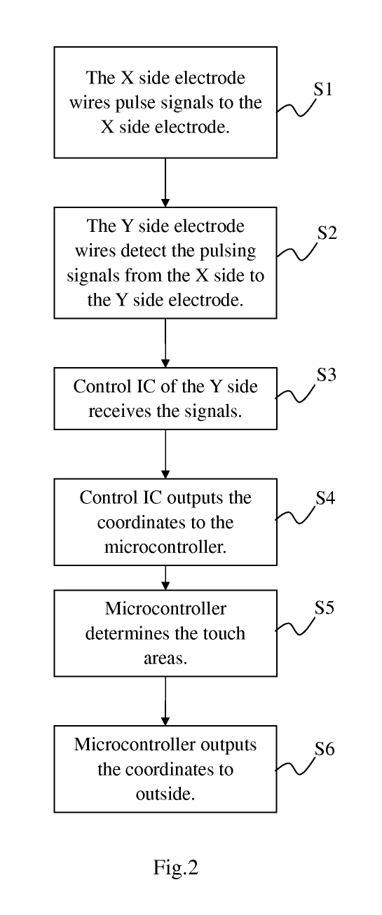

FIG. 3 shows a diagram of the conventional matrix resistive touch panel configuration.

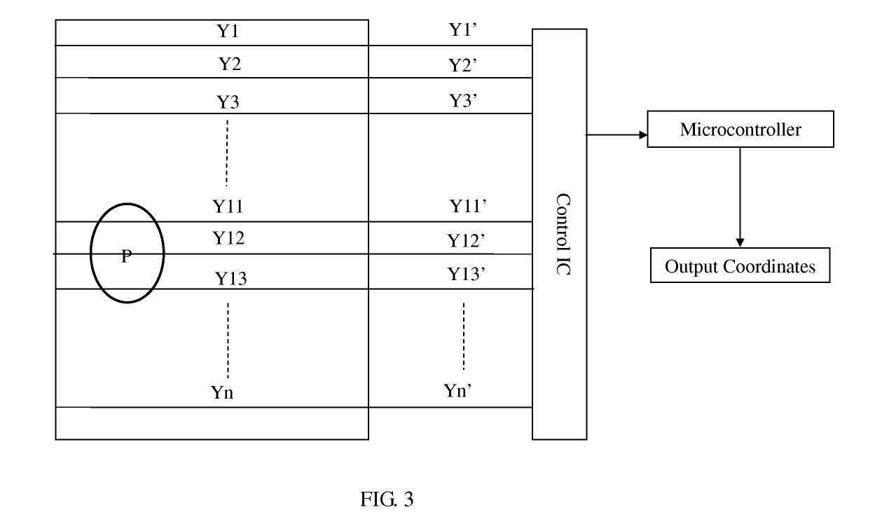

FIG. 4 shows a diagram of the system of the touch panel apparatus with shared output pins.

FIG. 5 shows a diagram of the touch panel apparatus with shared output pins configuration of the present invention.

FIG. 5A shows a diagram of the receiving circuit of single-touch of the touch panel apparatus with shared output pins of the present invention.

FIG. 6 shows a diagram of the touch panel apparatus with shared output pins configuration of the present invention.

FIG. 6A shows a diagram of the receiving circuit of multi-touch of the touch panel apparatus with shared output pins of the present invention.

### DETAILED DESCRIPTION OF THE PREFERRED EMBODIMENT

The invention hereinafter will be described in greater detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended claims.

The present invention provides a touch panel apparatus with shared output pins configuration of vertical electrodes, and more particularly to a matrix resistive touch panel which can reduce the computing data amount of the control IC to enhance the responding speed of the touch panel.

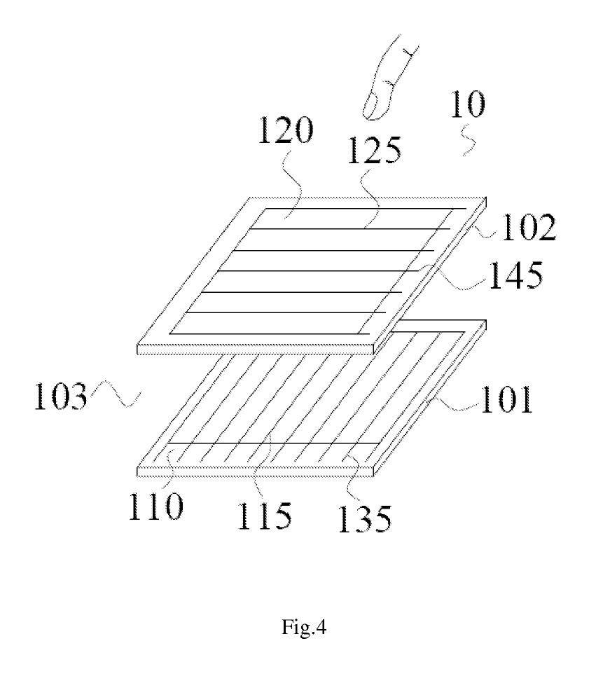

With reference to FIG. 4, a diagram of the system of the touch panel apparatus with shared output pins of the present invention. As shown in the figure, the touch panel apparatus 10 includes: a first substrate 101 with a first axis electrode layer 110 formed thereon, wherein the first axis electrode layer 110 including N first axis electrode wires 115; and a second substrate 102 with a second axis electrode layer 120 formed thereon, wherein the second axis electrode layer 120 includes M second axis electrode wires 125, and the second substrate 102 is disposed on the first substrate 101 correspondingly, and the first axis electrode wires 115 and the second axis electrode wires 125 are interlaced mutually to form a matrix configuration. In a preferred embodiment of the present invention, the first axis electrode wires 115 and the second axis electrode wires 125 are interlaced orthogonally. In an embodiment of the present invention, the touch panel apparatus further includes a space layer 103 alternatively disposed between the first axis electrode layer 110 and the second axis electrode layer 120 for separating the first axis electrode layer 110 and the second axis electrode layer 120. In an embodiment of the present invention, the touch panel apparatus includes a micro control unit (MCU) to receive the coordinates signals output from control IC. The N first axis electrode wires 115 are coupled with the N first axis pins 135 to transmit the pulsing signals and the M second axis electrode wires 125 are coupled with a control IC via the P second axis pins 145 to transmit the signals to control IC. The amount of second axis pins 145 is smaller than the amount of second axis electrode wires 125, that is, P is smaller than M, and the M second axis electrode wires 125 can be grouped and share the P second axis pins 145 with each other. In an embodiment of the present invention, at least two of the M second axis electrode wires 125 are coupled jointly to the same second axis electrode wires 125, wherein M, N, P are integers which are more than or equal to 1. In an embodiment of the present invention, the N first axis electrode wires 115 is the X side horizontal electrode and the second axis electrode wires 125 is the Y side vertical electrode. When user pressures on the touch point, the pulsing signals of X side horizontal electrode transmit to the Y side vertical electrode.

The present invention also provides a method for sharing output pins configuration of touch panel, the method includes the steps of grouping the K of M second axis electrode wires 125 into M/K electrode wire groups; and selecting one of the second axis electrode wires 125 from the one of electrode wire groups and one of the second axis electrode wires 125 from another the electrode wire groups are coupled jointly to one of the second axis pins 145, wherein the second axis pins 145 are plural S, M, K, S are integers, and K is more than or equal to 2. In an embodiment of the present invention, K is equal to 3, and one of the second axis electrode wires 125 of one of the electrode wire groups and one of the second axis electrode wires 125 of another said electrode wire groups are coupled jointly to one of the second axis pins 145.

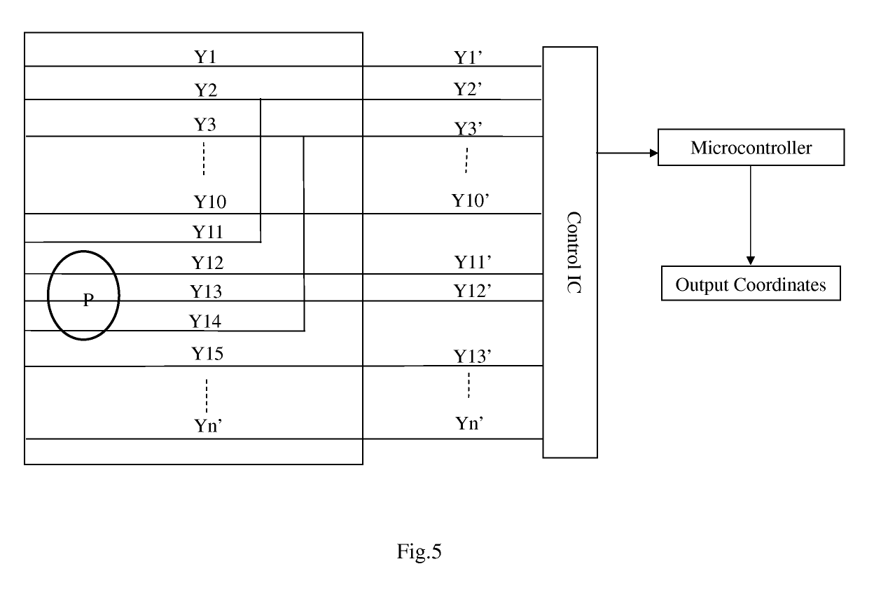

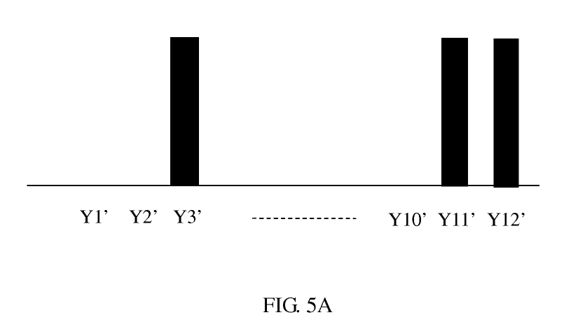

In another embodiment, with reference to FIG. 5, shows a diagram of the touch panel apparatus with shared output pins configuration. As shown in figure, the second axis electrode wires are grouped into every three electrode wires as a unit Y₁˜Y₃ . . . Y₁₀˜Y₁₂, then selecting a second axis electrode wires from every second axis electrode wire groups, an electrode wire of a electrode wire groups and an electrode wire of another electrode wire groups are coupled jointly with the second axis pins, and transmit signals to the Y side control IC. That is to say, the second axis electrode wires Y₂, Y₁₁ are coupled jointly with the pin Y_{2′}, and the second axis electrode wires Y₃, Y₁₄ are coupled jointly with the pin Y_{3′}, . . . and so on. After that, when the second axis electrode wires 125 output signals to the Y side control IC, the output signals of the second axis electrode wires Y₁₁, Y₁₄ output via the pins Y_{2′}, Y_{3′}.

With reference to FIG. 5A, shows a diagram of the receiving circuit of single-touch of the touch panel apparatus with shared output pins. The second axis electrode wires Y₃, Y₁₄ are coupled jointly with the pins Y_{3′}, thus when the touch point P at the Y₁₂, Y₁₃, Y₁₄, the received signals of the circuit are Y_{3′}, Y_{11′}, Y_{12′}. Then the Y side control IC transmits the signals to the MCU, and the MCU further determines the coordinate position of the signals. In this embodiment, if the finger touching area is point P as shown in the figure, the output signals of the pins Y_{3′}, Y_{11′}, Y_{12′} are high electric potential and Y_{1′}, Y_{2′} are low electric potential. Therefore, the touch point is P area.

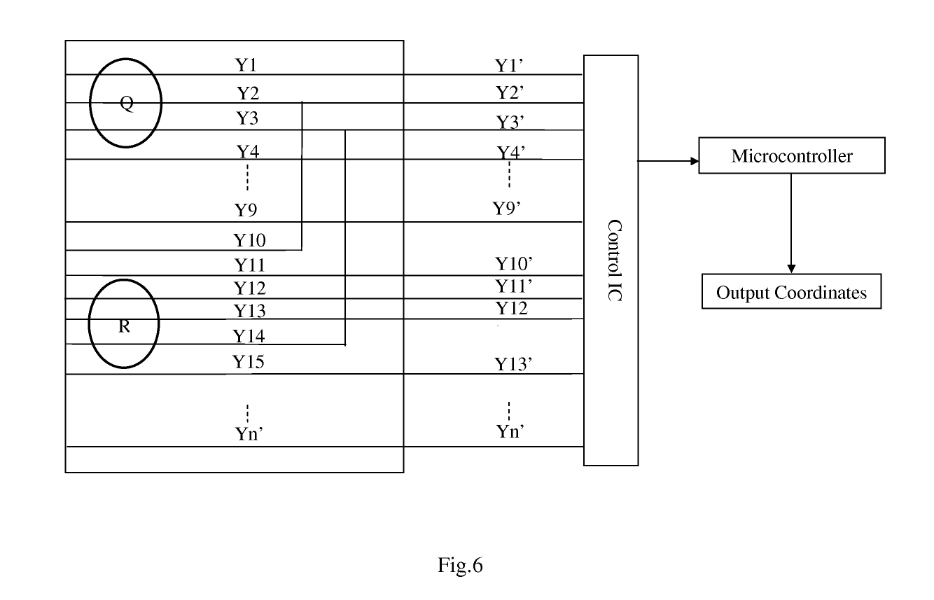

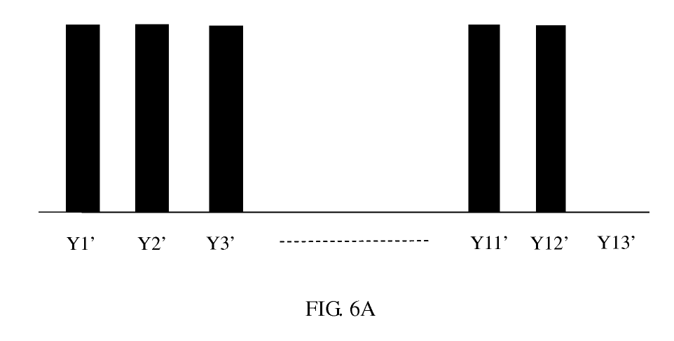

In another embodiment, with reference to FIG. 6, it shows a diagram of the touch panel apparatus with shared output pins configuration. As shown in figure, the second axis electrode wires are grouped into every four electrode wires as a unit Y₁˜Y₄ . . . Y₉˜Y₁₂, then selecting a second axis electrode wires from every second axis electrode wire groups, an electrode wire of a electrode wire groups and an electrode wire of another electrode wire groups are coupled jointly with the second axis pins, and transmit signals to the Y side control IC. Namely, the second axis electrode wires Y₂, Y₁₀ are coupled jointly with the pin Y_{2′}, and the second axis electrode wires Y₃, Y₁₄ are coupled jointly with the pin Y_{3′} . . . and so on. After that, when the second axis electrode wires 125 output signals to the Y side control IC, the output signals of the second axis electrode wires Y₁₀, Y₁₄ output via the pins Y_{2′}, Y_{3′}.

As shown in FIG. 6A, the user pressures on the touch points Q and R at the same time when the user induces a multi-touch action. The second axis electrode wires Y₂, Y₁₀ are coupled jointly with the pins Y_{2′}, and the second axis electrode wires Y₃, Y₁₄ are coupled jointly with the pins Y_{3′}, thus the received signals of the circuit are Y_{1′}, Y_{2′}, Y_{3′}, Y_{12′}. Then the Y side control IC transmits the signals to the MCU, and the MCU further determines the coordinate position of the signals. In this embodiment, if the finger touching areas are point Q, R as shown in the figure, the output signals of the pins Y_{1′}, Y_{2′}, Y₃ are high electric potential and Y_{11′}, Y_{12′} are also high electric potential. Therefore, the touch points are Q and R areas.

The present invention utilizes the logic computing method by the control IC to determine the various arrangement and combination of the output signals from electrode. In other words, the present invention utilizes the various arrangement and combination of the output pins and the logic computing method to increase the transmittable area of each pin, and instead of the conventional pin which only transmits the signals from single area to control IC. Therefore, the present invention can reduce the amount of the electrode output pins efficiently, and the computing data amount of the MCU is accordingly reduced.

In an embodiment of the present invention, the amount of pins of each group could be designed according to the touch panel application requirement and condition of the single-point or multi-point. Thus, there is no limited to the amount of above mentioned, and the embodiment only illustrate the preferred examples of the invention but not to limit the invention.

In an embodiment of the present invention, the first substrate 101 with the first axis electrode layer 110 and the second substrate 102 with the second axis electrode layer 120 are made of any material known by the person skill in the art, such as transparent conductive glass, Indium Tin Oxide Glass (ITO glass or ITO film), transparent plastic, acrylics or other transparent material, and the first axis electrode wires 115 and the second axis electrode wires 125 are preferably made of ITO.

The merits of the present invention are that the present invention can save the amount of the electrode output pins and economize the manufacture cost. Further, the present invention can reduce the computing data amount of the control IC to enhance the responding speed of the touch panel. The present invention can be collocated with application, such as the size of the products, and increase the efficiency of the touch panel by logic computing method.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A touch panel apparatus, including:
a first substrate with a first axis electrode layer formed thereon, wherein said first axis electrode layer includes N first axis electrode wires; and
a second substrate with a second axis electrode layer formed thereon, wherein said second axis electrode layer includes M second axis electrode wires, said second substrate is disposed on the said first substrate correspondingly, and said first electrode wires and said second electrode wires are interlaced mutually to form a matrix configuration;
wherein said N first axis electrode wires are coupled to N first axis pins to transmit pulsing signal, said M second axis electrode wires are coupled to a control IC via P second axis pins to output signal to said control IC, wherein P is less than M, and said M second axis electrode wires is grouped to share the said P second axis pins;
wherein M, N, P are integers and are more than or equal to 1.

2. A touch panel apparatus as claim 1, wherein said first axis electrode wires and said second axis electrode wires are interlaced orthogonally.

3. A touch panel apparatus as claim 1, further including a space layer disposed between said first axis electrode layer and said second axis electrode layer for separating said first axis electrode layer and said second axis electrode layer.

4. A touch panel apparatus as claim 1, wherein at least two of said M second axis electrode wires are coupled jointly to the one of said P second axis pins.

5. A touch panel apparatus as claim 4, wherein the K of said M second axis electrode wires are taken as a unit and said M second axis electrode wires are divided into M/K electrode wire groups, at least one said second axis electrode wire of one of said electrode wire groups and at least one said second axis electrode wire of another said electrode wire groups are coupled jointly to one of said P second axis pins, wherein K is an integer and is more than or equal to 2.

6. A touch panel apparatus as claim 5, wherein K is equal to 3, and at least one said second axis electrode wire of one of said electrode wire groups and at least one said second axis electrode wire of another said electrode wire groups are coupled jointly to one of said second axis pins.

7. A touch panel apparatus as claim 1, further including a micro controller unit for receiving a coordinate signal from said control IC.

8. A touch panel apparatus as claim 1, wherein the materials of said first substrate and said second substrate comprise are transparent conductive glass or transparent plastic.

9. A touch panel apparatus as claim 1, wherein said control IC determine the output signals of said control IC by logic operation.

10. A method for sharing output pins configuration of touch panel, including:
grouping the K of M second axis electrode wires into M/K electrode wire groups; and
at least one said second axis electrode wire from one of said electrode wire groups and at least one said second axis electrode wire from another said electrode wire groups are coupled jointly to one of said P second axis pins;
wherein K is an integer and is more than or equal to 2 and less than M.

11. A method of sharing output pins configuration of touch panel as claim 10, wherein K is equal to 3, and one of said second axis electrode wire of one of said electrode wire groups and one of said second axis electrode wire of another said electrode wire groups are coupled jointly to the one of said P second axis pins.
